(19) United States
(12) Patent Application Publication
(10) Pub. No.: US 2017/0122566 A1
(43) Pub. Date: May 4, 2017

(54) Mechanical Attachment of Support Housing Rocket

(71) Applicant: Siemens Energy, Inc., Orlando, FL (US)

(72) Inventors: Keith W. Piersall, Winter Springs, FL (US); Mark Murray Carter, Orlando, FL (US)

(21) Appl. No.: 15/403,746

(22) Filed: Jan. 11, 2017

Related U.S. Application Data
(63) Continuation-in-part of application No. 14/709,974, filed on May 12, 2015.

(51) Int. Cl. F23R 3/28; F02C 7/22

(52) U.S. Cl. CPC F23R 3/283; F02C 7/222; F23R 2900/00012; F23R 2900/00017; F05D 2220/32; F05D 2240/35; F05D 2230/60

(57) ABSTRACT

A field configurable support housing assembly 10 is provided. The support housing assembly comprises a support housing base 20 and a cylindrical hollow fuel rocket 40. The support housing base 20 includes at least one through hole. The cylindrical hollow fuel rocket 40 includes a nozzle tip 50 positioned such that the hollow fuel rocket 40 generally aligns with the through hole. The fuel rocket 40 is reconfigurable on-site using a mechanical attachment 100. A method for rapid on-site reconfiguration of a cylindrical hollow fuel rocket 40 is also provided.

This application claims benefit of the May 12, 2015, filing date of US application 14/709,974 which is incorporated by reference herein.

### BACKGROUND

1. Field

The present disclosure relates generally to a combustion system of a turbine engine, and more particularly to a field configurable support housing assembly and a method for rapid on-site reconfiguration of a fuel rocket.

2. Description of the Related Art

In a turbomachine, such as a gas turbine engine, air is pressurized in a compressor section then mixed with fuel and burned in a combustion section to generate hot combustion gases. The hot combustion gases are expanded within a turbine section of the engine where energy is extracted from the combustion gases to power the compressor section to produce useful work, such as turning a generator to produce electricity.

Turbine engine fuel systems typically include a pilot nozzle surrounded by a circumferential configuration of fuel rockets for injecting fuel into the combustor. Conventionally, the pilot nozzle is bolted to a support housing assembly and the fuel rockets are welded to the support housing assembly which attaches the pilot nozzle and the fuel rockets to the turbine engine. Typical support housing includes a base having orifices extending through the base to receive the pilot nozzle and the fuel rockets.

Heat and gases generated from the combustion process may shorten the life of the combustor components, including the components making up the pilot nozzle and the fuel rockets. For example, oxidation and/or burning and wear of the support rocket tips may cause damage necessitating that the support housing be sent to a repair facility for repair or replacement during an engine outage. Sending the entire support housing assembly to a repair facility is expensive and may take an undesirable amount of time to replace it in the turbine engine. The ability to replace the pilot nozzle components and the fuel rocket components in the field would enable a greater number of support housing and pilot nozzle assemblies to continue normal operation in the turbine and reduce the time the turbine is in an outage.

### SUMMARY

Briefly described, aspects of the present disclosure relate to a field configurable support housing assembly and a method for rapid on-site reconfiguration of a cylindrical hollow fuel rocket.

A field configurable support housing assembly is provided. The support housing comprises a support housing base and a cylindrical hollow fuel rocket. The support housing base includes at least one through hole. The cylindrical hollow fuel rocket includes a nozzle tip positioned such that the hollow fuel rocket generally aligns with the through hole. The fuel rocket is reconfigurable on-site using a mechanical attachment.

A method for rapid in-situ reconfiguration of a cylindrical hollow fuel rocket is provided. The method includes mechanically coupling a cylindrical fuel rocket to the support housing on-site and clocking the coupled support housing and fuel rocket such that a tip of the fuel rocket is oriented at a predetermined angular orientation relative to a flow-guiding element.

### BRIEF DESCRIPTION OF THE DRAWINGS

FIG. 1 illustrates a perspective view of a fuel rocket assembly,

FIG. 2 illustrates a cross section of a conventional fuel rocket welded to a support housing collar,

FIG. 3 illustrates a cross section of a first embodiment of a fuel rocket mechanically attached to a support housing, and

FIG. 4 illustrates a second embodiment of a fuel rocket mechanically attached to a support housing.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

The present application proposes an attachment scheme to mechanically attach a fuel rocket to a support housing on-site. On-site, in the context of the application, may mean on the grounds of the plant in which the gas turbine is installed or a location within a 5 mile radius of the gas turbine plant. This mechanical attachment scheme may replace the previously described conventional welded attachment scheme. Replacing a fuel rocket having a conventionally welded attachment scheme requires that the rocket be cut off, the surfaces of the support housing as well as the mating surface of the fuel rocket to be re-machined, and a new fuel rocket to be welded on in a repair facility. Mechanically attaching the fuel rocket to the support housing may enable a quick on site repair.

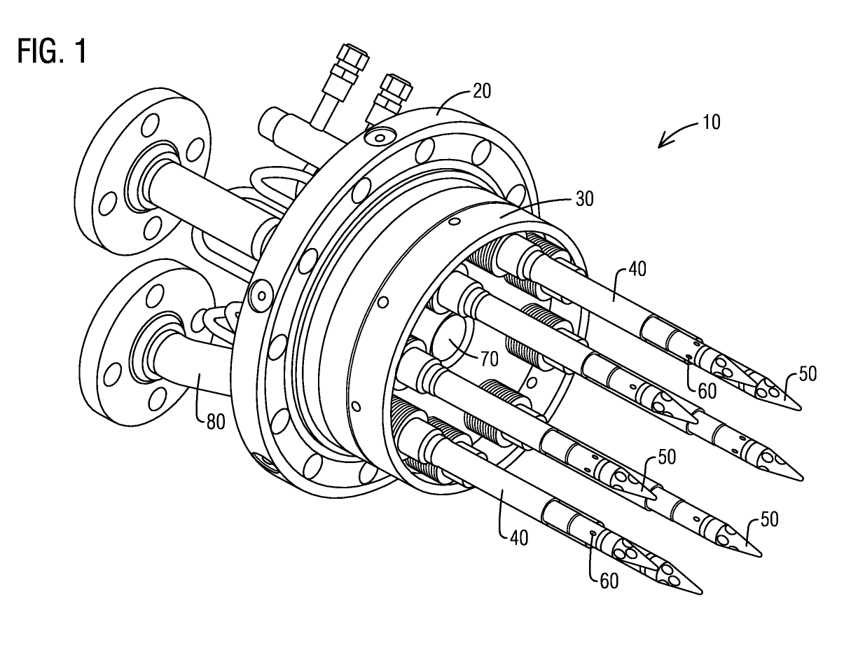

Referring to FIG. 1, a support housing assembly 10 for a gas turbine engine is illustrated. The support housing assembly 10 includes a base 20, fuel support ports 80, and a plurality of fuel rockets 40. The fuel rockets including a nozzle tip 50 which includes the fuel metering orifice 60. The central orifice 70 may receive a pilot nozzle. Fuel enters the support housing assembly 10 via the fuel supply ports 80 and is distributed to the fuel rockets 40 by internally cast passages in the base 20. The fuel exits the support housing assembly 10 and enters the combustion chamber through the fuel rocket orifices 60. The plurality of fuel rockets 40 may be disposed in a circumferential arrangement around a central orifice 70. The central orifice 70 may receive a pilot nozzle. In the shown embodiment, eight fuel rockets 40 are disposed in a circumferential arrangement around the central orifice 70, however, other arrangements of fuel rockets 40 may also be applicable for the proposed support housing assembly 10.

Each fuel rocket 40 may be configured as a hollow cylinder configured to deliver fuel gas to a combustion system. One end of the fuel rocket 40, illustrated as the upstream end, may be attached to the support housing base 20. Another opposite, downstream end of the fuel rocket 40 may include a nozzle tip 50 including one or more fuel flow orifices 60 through which a fuel may flow into a combustion system, for example. Generally, during operation, one of two fuels, gas or oil, is supplied by respective supply lines, shown generally as 80, leading into the support housing base 20. The respective fuel passes through the support housing base 20, then through the fuel rockets 40 and into the combustion system.

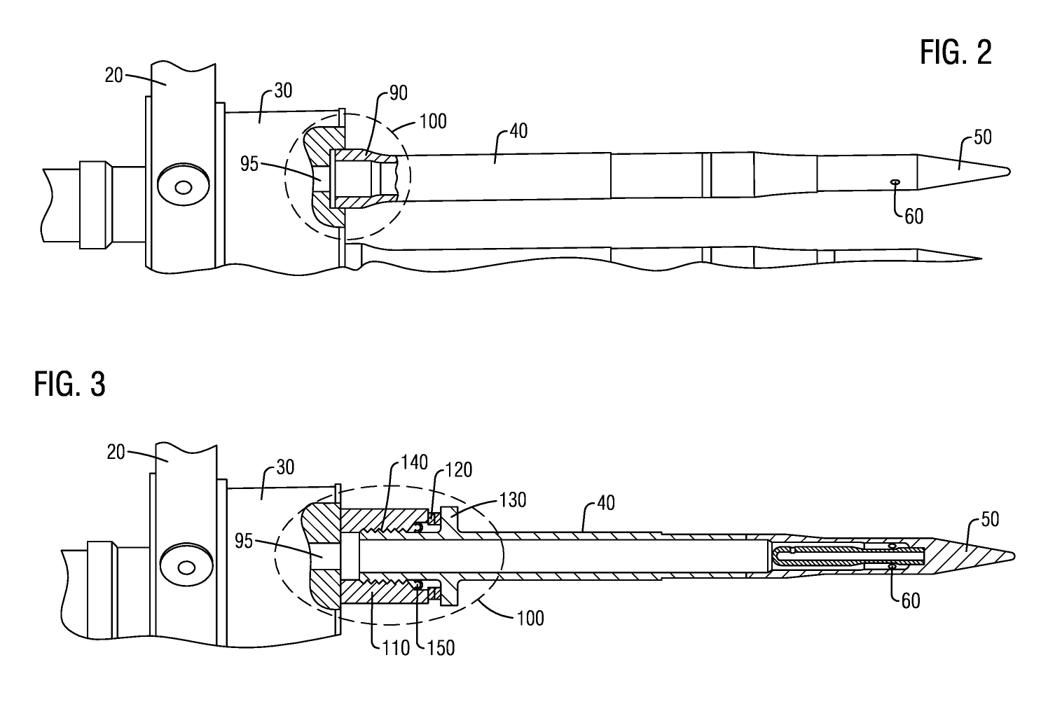

FIG. 2 illustrates a cross section of a conventional fuel rocket 40 in which the fuel rocket 40 is attached to the support housing base 20 by a weld 90. The nozzle tip 50 may be manufactured integral with the remaining portion of the fuel rocket. Generally speaking, most of the damage to the fuel rocket 40 occurs at the nozzle tip 50. This damage may include wear and/or oxidation and is due to, for example, a flashback occurrence where the flame travels backwards in a direction away from the turbine section. A flame flashback may cause damage to the nozzle tips as these components are not typically designed to withstand such high temperatures. In order for any of the fuel rocket components to be repaired or replaced, including the nozzle tip 50, the entire support housing assembly is removed and sent to a repair facility where the welded connections are dismantled. A replacement support housing assembly 10 must be supplied to the site to replace the removed support housing assembly.

FIG. 3 illustrates an embodiment of a cross section of a proposed fuel rocket 40 mechanically attached to a support housing base 20. In the shown embodiment, the support housing base 20, includes an internally cast hole 95 through which fuel flows into the hollow interior of the fuel rocket 40. The fuel rocket 40 may be coupled to the support housing base 20 using a non-welded mechanical attachment 100 enabling the replacement of the fuel rocket assembly on-site. Only conventional tools, such as a wrench, would be required for the repair/replacement. Enabling the easy removal and replacement of the fuel rockets 40 where the majority of support housing damage occurs would eliminate the need to replace the entire support housing assembly 10 and ship it into a repair facility for refurbishment.

The mechanical attachment 100 for the illustrated fuel rocket 40 includes a threaded joint such that the exterior surface of the upstream end 140 of the fuel rocket 40 is threaded. The threaded upstream end 140 will be used to mechanically couple the fuel rocket 40 to the support housing base 20. The threads could be tapped directly into the cast hole 95 or a gas turbine component 110 may abut the support housing base 20 and may be positioned so that its hollow interior is coaxial with the through-hole of the support housing base 20. The gas turbine component 110 may be a bushing. The gas turbine component 110 will be referred to hereinafter as a bushing 110, however, other gas turbine components may also be used. The bushing 110 may be attached to the support housing base 20 by a weld, for example. The interior surface of a downstream end of the bushing 110 may include threads such that this threaded portion receives the threaded upstream end 140 of the fuel rocket 40. When assembled, the threaded portions of the fuel rocket 40 and the bushing 110 interengage coupling the fuel rocket 40 and the bushing 110 together. Wrench flats 130 are provided to properly torque the fuel rocket 40 to the threaded bushing 110.

The mechanical attachment 100 includes a bushing 110 which is shown surrounding the fuel rocket 40 and coupled to the fuel rocket 40 by the threaded connection. A locking spring washer 120 is disposed to prevent the fuel rocket 40 from backing out during operation. A seal 150 may be incorporated to seal the interface such that the fuel remains in the fuel passage.

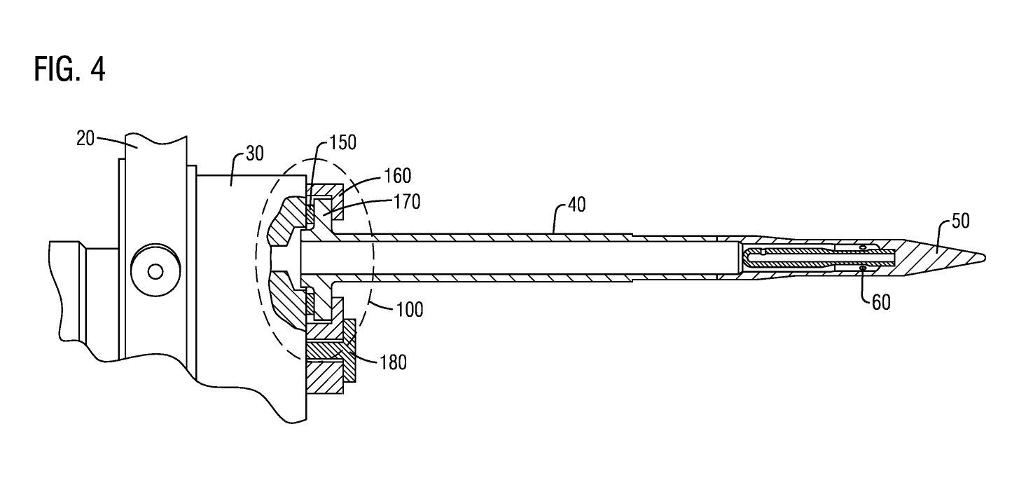

FIG. 4 illustrates a further embodiment of a cross section of a fuel rocket 40 mechanically attached to a support housing base 20. In the shown embodiment, the mechanical attachment 100 includes a bolt on flange seal. The bolt on flange seal comprises a flange retainer 160. The flange retainer 160 may be welded onto a surface of the support housing base 20. The flange retainer 160 may be made integral with the fuel rocket 40. An outer surface of upstream end of the fuel rocket 40 includes a stepped portion 170 such that the stepped portion 170 fits within the flange retainer 160. A fastener 180, such as a bolt, secures the flange retainer and the fuel rocket 40 to the support housing base 20 mechanically coupling the fuel rocket 40 to the support housing base 20. A seal 150 is disposed within a gap between the stepped portion 170 of the fuel rocket 40 and a surface of the support housing base 20.

Referring to FIGS. 1-4, a method for rapid on-site reconfiguration of a fuel rocket assembly 10 is provided. The method includes mechanically coupling the fuel rocket 40 to the support housing on-site. Additionally, the method includes clocking the coupled fuel rocket 40 such that a tip 50 of the fuel rocket 40 is oriented at a predetermined angular orientation relative to a flow guiding element.

In an embodiment, the mechanical coupling of the fuel rocket 40 to the support housing base 20 on-site includes providing a gas turbine component 110 having an internal threaded portion attached to the support housing base 20. For example, the gas turbine component 110 may be a bushing having internal threads. The fuel rocket 40 includes an outer surface having a threaded upstream end 140. The internal threaded portion of the bushing 110 and the threaded upstream end 140 are threaded together such that the internal threaded portion and the threaded upstream end 140 interengage and couple the fuel rocket 40 to the support housing base 20. The threaded connection is secured using the provided wrench flats 130. The fastener 130 may be a hex nut, for example. A seal 150 may be disposed within a gap between a locking spring washer 120, the threaded upstream end, and the fuel rocket 40. The seal 150 creates a sealed interface such that a fuel flowing through the hollow fuel rocket 40 is sealed within the fuel rocket 40.

In another embodiment, the mechanical coupling of the fuel rocket 40 to the support housing base 20 on-site includes providing a gas turbine component attached to the support housing base 20, the gas turbine component comprising a flange retainer 160. The flange retainer 160 is positioned relative to the support housing base 20 such that a through hole in the support housing base 20 aligns with a through hole in the flange retainer 160. The cylindrical fuel rocket 40 would then be positioned such that the hollow fuel rocket 40 aligns with the through hole. The fuel rocket 40 includes a stepped portion 170 on its outer surface. The stepped portion 170 abuts an interior surface of the flange retainer 160. The flange retainer and the fuel rocket may be secured to a surface of the support housing using a fastener. A seal may be disposed within a gap between the stepped portion of the fuel rocket and a surface of the support housing. The fastener may compress the seal and create a sealed interface such that a fuel flowing through the hollow fuel rocket is sealed within the fuel rocket.

The coupled support housing base 20 and fuel rocket 40 may be clocked such that a tip 50 of the fuel rocket 40 is oriented at a predetermined angular orientation.

Using the described embodiments of the mechanical attachments, the fuel rocket 40 may also be decoupled from the support housing on-site. The method steps described previously may be performed in reverse, for example, untightening the fastener 130 and unthreading the fuel rocket 40 from the internally threaded gas turbine component.

In an embodiment, the support housing is attached to a gas turbine engine during the mechanical coupling of the fuel rocket to the support housing on-site.

The ability to couple and uncouple the fuel rocket 40 and the support housing base 20 on-site may enable customization of fuel rocket 40 having an orifice size to specific field site conditions. The specific field site conditions may include environmental conditions at the field site or may include the particular requirements of the gas turbine.

Mechanical attachment of the fuel rocket to the support housing would allow the rocket to be replaced in the field with conventional tools while reducing the scope and/or cost of the repair. The embodiments illustrated use gas only fuel rockets, however, one skilled in the art would appreciate that other fuel rockets including dual fuel (gas and liquid) may be mechanically coupled to the support housing of the gas turbine engine using the proposed fuel rocket assembly and method. Pilot nozzles could also use the proposed assembly method.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A field configurable support housing assembly 10, comprising:
a support housing base 20, the base including at least one through hole; and
a cylindrical hollow fuel rocket 40 including a nozzle tip 50, positioned such that the hollow fuel rocket 40 generally aligns with the through hole,
wherein the fuel rocket 40 is reconfigurable on-site using a mechanical attachment 100.

2. The support housing assembly 10 as claimed in claim 1, wherein the mechanical attachment 100 is a threaded joint.

3. The support housing assembly 10 as claimed in claim 1,
wherein the exterior surface of an upstream end of the fuel rocket 40 is threaded, and
wherein a gas turbine component 110 includes a downstream end including an interior threaded surface portion such that the threaded portions of the fuel rocket 40 and the gas turbine component 110 interengage when assembled to couple the fuel rocket 40 and the gas turbine component together.

4. The support housing assembly 10 as claimed in claim 3, the mechanical attachment 100 includes:
the gas turbine component 110 attached to the support housing base 20, the gas turbine component 110, comprising a bushing 110 including a downstream end having an interior surface threaded portion, the bushing 110 generally coaxial with the through hole, the threaded bushing 110 receiving the threaded upstream end 140 of the fuel rocket 40,
a locking spring washer 120 disposed between the bushing 110 and the collar 30,
and
a seal 150, the seal 150 disposed within a gap between the upstream end of the fuel rocket 40 and the bushing 110 creating a sealed interface.

5. The support housing assembly 10 as claimed in claim 1, wherein the mechanical attachment 100 includes a bolt on flange seal.

6. The support housing assembly 10 as claimed in claim 5, the mechanical attachment comprises:
a flange retainer 160;
a fastener 180 securing the flange retainer 160 and the fuel rocket 40 to a surface of the support housing base 20;
a seal 150, the seal 150 disposed within a gap between the fuel rocket 40 and a surface of the support housing base 20,
wherein the fuel rocket 40 includes a stepped portion 170 on the outer surface,
wherein the outer surface of the stepped portion abuts an interior portion of the flange retainer, and
wherein the seal is compressed by a tightened fastener creating a sealed interface between the stepped portion, and the support housing base 20.

7. The support housing assembly 10 as claimed in claim 1, wherein the nozzle tip 50 is disposed at an opposite end from the threaded upstream end of the fuel rocket 40,
wherein the nozzle tip 50 includes at least one orifice 60, 70 through which a fuel flows.

8. The support housing assembly 10 as claimed in claim 6, wherein the nozzle tip 50 includes threads which are received by a threaded opposite end of the fuel rocket 40.

9. The support housing assembly 10 as claimed in claim 1, wherein a plurality of fuel rockets 40 are attached to the support housing base 20 and disposed in a circumferential arrangement around a central orifice 70 in the support housing base 20.

10. A method for rapid on-site reconfiguration of a cylindrical hollow fuel rocket 40, comprising:
mechanically coupling a cylindrical fuel rocket 40 to the support housing base 20 on-site; and
clocking the coupled support housing 20, 30 and fuel rocket 40 such that a tip of the fuel rocket 40 is oriented at a predetermined angular orientation relative to a flow-guiding element.

11. The method as claimed in claim 10, further comprising:
providing a gas turbine component 110 attached to the support housing 20, 30 having an internal threaded portion;
threading a threaded outer upstream end 140 of a fuel rocket 40 with the internal threaded portion of the gas turbine component 110 such that when assembled the threaded upstream end 140 and the internal threads interengage and couple the fuel rocket 40 to the support housing 20, 30; and
wherein a seal 150 is disposed within a gap between the gas turbine component 110 and, the threaded outer upstream end of the fuel rocket 40 creating a sealed interface.

12. The method as claimed in claim 10, further comprising:
providing a gas turbine component attached to the support housing comprising a flange retainer 160 such that a through hole in the support housing base 20 generally aligns with a through hole in the flange retainer 160;
positioning the cylindrical fuel rocket 40 such that the hollow fuel rocket 40 generally aligns with the through hole and a stepped portion 170 of the outer surface of the cylindrical fuel rocket 40 abuts an interior surface of the flange retainer 160,
securing the flange retainer 160 and the fuel rocket 40 to a surface of the support housing 20 using a fastener 180;
wherein a seal 150 disposed within a gap between the fuel rocket 40 and a surface of the support housing is compressed by a tightened fastener 180 creating a sealed interface between the stepped portion 170 and the support housing base 20.

13. The method as claimed in claim 10, further comprising mechanically decoupling the fuel rocket 40 on-site.

14. The method as claimed in claim 10, wherein the fuel rocket 40 comprises fuel orifices sized to address specific field site conditions.

15. The method as claimed in claim 10, wherein the support housing assembly 10 is attached to a gas turbine engine.
